(19) United States
(12) Patent Application Publication
(10) Pub. No.: US 2011/0311697 A1
(43) Pub. Date: Dec. 22, 2011

(54) POMEGRANATE SEED EXTRACTOR

(76) Inventor: Dix R. FRAMPTON, Pahrump, NV (US)

(21) Appl. No.: 13/095,172

(22) Filed: Apr. 27, 2011

(30) Foreign Application Priority Data
Jun. 18, 2010 (CN) 201010211735.0

(51) Int. Cl. A23N 4/00; A23P 1/00; A23L 1/212

(52) U.S. Cl. 426/484; 99/537

(57) ABSTRACT

In one aspect of the disclosed embodiments a pomegranate seed extractor has an open-ended housing with a top edge and a bottom edge. A grate is mounted inside the housing between the top edge and bottom edge of the housing. The grate includes at least one circular core rib and a plurality of radial ribs. A plurality of openings is formed by the intersections between the core rib and the radial ribs. By placing a sliced pomegranate on top of the grate and repeatedly striking it, pomegranate seeds are extracted and separated from the septum and rind of the pomegranate.

### CROSS-REFERENCE TO RELATED APPLICATIONS

This application claims priority to Chinese Application No. 201010211735.0 filed Jun. 18, 2010, the contents of which are incorporated herein by reference in their entirety.

### FIELD

The following description relates generally to fruit processing devices, and in particular to a device for extracting seeds from the pomegranate fruit.

### BACKGROUND

The pomegranate is a nutritious fruit that has recently been recognized as a significant source of antioxidants, phytochemicals and other healthy micronutrients. However, the edible nutritious portion of the pomegranate is the seeds, which are difficult to separate from the inedible (or undesirable) portions such as the septum and rind. In the past, people have manually separated pomegranate seeds from the septum and rind. However, this is a slow and tedious process that also can lead to contamination of the seeds caused by impurities on hands of the people processing the pomegranate.

An apparatus for separating the seeds from the septum and rind has also been described (see, e.g., http://www.mshoham.com/site/pages/homepage.asp). However, this device has a multiple-piece design, a grate with essentially round openings, and a closed receptacle that make it slower and more awkward to use than would ideally be desirable.

Accordingly, there is a need for a device for separating pomegranate seeds from the rest of the fruit, and in particular from the septum and rind of the fruit. Ideally, such a device would improve the speed and efficiency of the seed separation process, and would prevent contamination of the pomegranate seeds generally caused by contact with the hands when seed separation is performed manually. The embodiments disclosed below satisfy these needs.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments a pomegranate seed extractor has an open-ended conical housing having a top circular edge and a bottom circular edge, each circular edge defining a circumference, wherein the circumference of the top circular edge is smaller than the circumference of the bottom circular edge. A grate is mounted inside the housing adjacent to the top circular edge of the housing and spaced above the bottom circular edge of the housing thereby forming a seed collection chamber beneath the grate inside the housing. The grate includes at least one circular core rib and a plurality of radial ribs extending outwardly from the circular core rib. A plurality of essentially quadrilateral openings is thereby formed between the core rib, adjacent radial ribs and the housing.

A method of extracting seeds from a pomegranate is also provided. The method includes, providing a pomegranate seed extractor with an open-ended conical housing having a top circular edge and a bottom circular edge, each circular edge defining a circumference. The circumference of the top circular edge is smaller than the circumference of the bottom circular edge. A grate is mounted inside the housing adjacent to the top circular edge of the housing and spaced above the bottom circular edge of the housing thereby forming a seed collection chamber beneath the grate inside the housing. The grate includes at least one circular core rib and a plurality of radial ribs extending outwardly from the circular core rib. A plurality of essentially quadrilateral openings is formed between the core rib, adjacent radial ribs and the housing. Next a pomegranate having a rind, septum and seeds is provided. The pomegranate is separated or sliced into at least two separate pieces each having a sliced or open end. One sliced piece of the pomegranate is placed on top of the grate with the sliced or open end facing down and contacting the grate. Then, rind of the half-pomegranate is repeatedly struck thereby causing the seeds of the pomegranate to fall through the grate into the housing while leaving the rind and septum of the pomegranate on top of the grate.

Furthermore, the method of extracting seeds from a pomegranate may further include identifying parallel vertical ridges on the rind of the pomegranate, creating a circumferential slice around the middle of the pomegranate perpendicular to the parallel vertical ridges on the rind, and then scoring the parallel vertical ridges on the rind of the pomegranate. The pomegranate is then separated into two pieces along the circumferential slice to create at least two separate pieces of the pomegranate. In some embodiments, the piece of pomegranate is repeatedly struck with a blunt instrument in order to jolt the pomegranate seeds loose from the septum and rind of the pomegranate.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the attached drawings.

### BRIEF DESCRIPTION OF THE DRAWINGS

FIG. 1 is a perspective view of one embodiment of a pomegranate seed extractor.

FIG. 2 is a front elevation view of the embodiment of FIG. 1.

FIG. 3 is a front elevation view of another embodiment of a pomegranate seed extractor.

### DETAILED DESCRIPTION

In one aspect of the disclosed embodiments, a pomegranate seed extractor includes a cylindrical or conical housing in which a grate is mounted. The grate is disposed slightly below the upper surface of the housing. The grate includes a plurality of radial ribs extending radially from a circular core, and a plurality of circular ribs concentric with the circular core. The intersections between the radial ribs and the circular ribs form a plurality of seed-extracting openings. By placing a half-pomegranate on top of the grate in the housing and then repeatedly striking the pomegranate with a blunt instrument, the seeds of the pomegranate are jolted loose and fall through the grate to the bottom of the housing. The extracted seeds can then be harvested for consumption or other uses. The remainder of the pomegranate, namely the rind and septum, can then be discarded or used for other purposes.

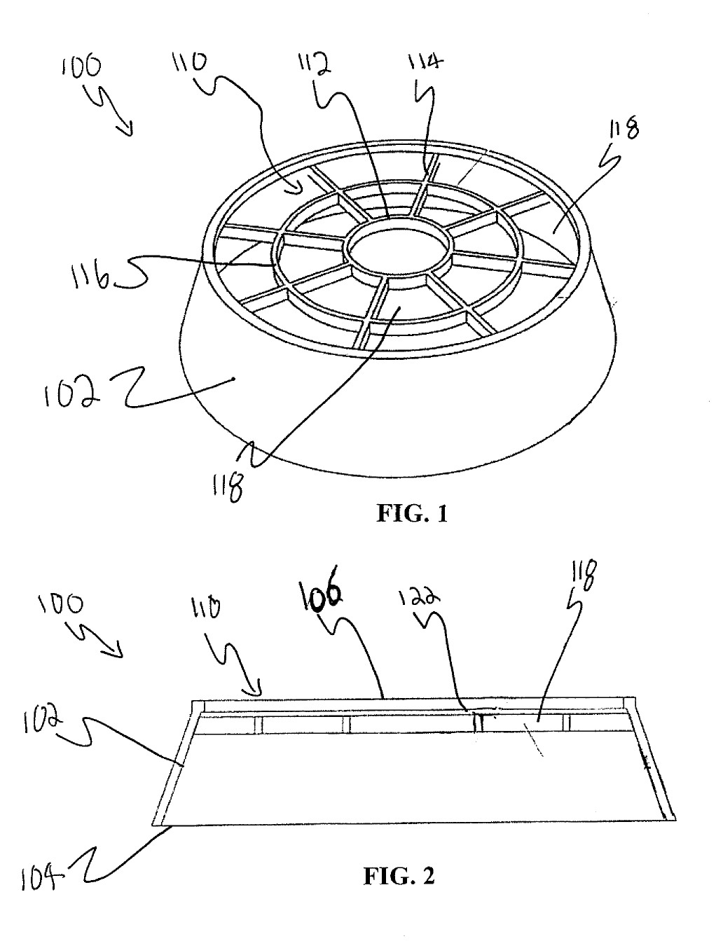

FIG. 1 shows a perspective view of one embodiment of a pomegranate seed extractor 100. Seed extractor 100 includes open-ended housing 102 which may be cylindrical or conical, though in the illustrated embodiment housing 102 is conical with the smaller open top edge on the upper end of housing 102. Mounted within housing 102 is grate 110. Grate 110 includes at least circular core rib 112 and radial ribs 114. Grate 110 may also include one or more additional circular ribs, such as circular rib 116. It can thus be seen that the intersection between core rib 112, radial ribs 114 and any circular ribs 116 creates a plurality of openings 118 between the various ribs. The lower end 104 of housing 102 is spaced below grate 110 in order to provide sufficient room beneath grate 110 and inside housing 102 for collection of seeds. Side wall 109 of housing 102 is disposed at an angle relative to vertical due to the relative size discrepancies of upper edge 106 and lower edge 104. In some embodiments, the angle of side wall 109 relative to vertical is between 15° and 50°. This difference in relative sizes between upper edge 106 and lower edge 104, and the angle of side wall 109, allows for clean and efficient collection of pomegranate seeds.

Additionally, upper edge 106 of housing 102 may be disposed above grate 110 so that there is a gradual downward slope from upper edge 106 to the center of grate 110. The exact angle of the slope is not critical, but in some embodiments may be between 1 mm and 1 cm of vertical spacing between the upper edge 106 and the center of grate 110. By providing housing 102 and grate 110 with this slope, the efficiency of splaying open and extracting pomegranate seeds is improved, as will be described in further detail below.

FIG. 2 shows a front elevation view of pomegranate seed extractor 100. In this view it can be seen that grate 110 has an upper surface 122 that is mounted slightly below an upper edge 106 of housing 102. Housing 102 is dimensioned so as to be slightly larger in diameter than a typical pomegranate so that if a pomegranate is cut in half, it can be placed on top of seed extractor 100 with the cut side of the pomegranate contacting upper surface 122 of grate 110. Once a cut pomegranate is thusly placed on top of grate 110, the seeds of the pomegranate can be extracted by repeatedly striking the pomegranate with a blunt instrument such as a kitchen spoon, a wooden mallet, a fist, or any other suitable object. The seeds are thus jolted loose from the septum and rind of the pomegranate and fall through openings 118 in grate 110 until they fall through housing 102 beyond lower edge of 104 of housing 102 where they can be collected. The septum, rind and other undesirable portions of the pomegranate remain on top of housing 102 of seed extractor 100. In this way, seed extractor 100 can be used to remove the seeds of a pomegranate quickly, efficiently, and without risk of contamination due to contact with human hands.

Grate 110 is dimensioned so as to optimize the ability of seed extractor 100 to separate pomegranate seeds from the rest of the fruit. For example, grate 110 is mounted in housing 102 such that upper surface 122 of grate 110 is disposed approximately 1 mm-10 mm below upper edge 106 of grate 110. Further, the upper surface 122 of grate 110 may be gradually sloped inwardly from outer upper edge 106 of housing 102 to the center of grate 110. Each radial rib 114 and any circular ribs 116 are approximately 0.5 mm-3 mm wide. The openings 118 formed between the ribs 114 and 116 have a total area of approximately 2 cm² to 10 cm². In particular, the total area of each opening 118 may be approximately 5 cm². By providing openings 118 of this size, the seeds of the pomegranate are allowed to pass through openings 118 while the rest of the pomegranate is too large to pass through openings 118 and remains on top of housing 102.

The dimensions of seed extractor 100 are not critical but, as explained above, are ideally selected so that seed extractor 100 is particularly suited for removing seeds from pomegranates. For example, if a typical pomegranate is 5 cm-12 cm in diameter, the diameter of housing 102 may be approximately 12 cm-15 cm to ensure that seed extractor 100 is large enough to accommodate a typical pomegranate. Further, housing 102 may be approximately 5 cm in height to ensure sufficient space for receiving pomegranate seeds as they are pushed through grate 110. However, it is to be understood that the dimensions disclosed above are not critical and are not intended to limit the scope of the appended claims.

Finally, the materials used in the construction of seed extractor 100 are also not critical. However, in some embodiments, housing 102 may be made from any suitable plastic or metal. Grate 110 may also be made from any material including plastic or stainless steel. Persons skilled in the art will be aware that a wide variety of materials may be used to construct seed extractor 100.

In order to use seed extractor 100, a user may simple cut a pomegranate in half and place one half on top of the grate with the sliced side facing down. However, the efficiency of seed extraction can be optimized by first scoring the pomegranate such that it will more easily open up or splay open when it is repeatedly struck on top of the grate. To do so, the user first identifies the parallel vertical ridges on the rind of the pomegranate and then creates a circumferential slice around the middle of the pomegranate perpendicular to the vertical ridges. Next, the user scores each of the vertical ridges in order to create areas of weakness that will tear easily when the user later repeatedly strikes the pomegranate on top of the grate. The user then pries the prepared pomegranate in half by inserting a knife or other slender object into the circumferential slice and manipulating the knife until the two halves are separated. It should be noted that “prying” the pomegranate into two pieces is different from “cutting” the pomegranate into two pieces. “Cutting” the pomegranate requires plunging a knife blade through the entire fruit, while “prying” only requires a relatively small incision. By prying the pomegranate into two pieces, as opposed to slicing it, the pomegranate will break and separate without any damage to the seeds inside.

Once the pomegranate is separated into two halves, the user then places one of the halves of the pomegranate on top of the grate of the seed extractor and then repeatedly strikes the rind of the pomegranate with a blunt object. The seeds are jolted loose and fall through the grate. Due to the scores in the ridges of the pomegranate, the pomegranate tends to spread or splay open as it is struck. The tendency of the pomegranate to splay open in this manner is facilitated by providing a downward slope from the upper outer edge 106 of the housing 102 to the center of the grate 110. The downward slope from the outside of housing 102 to the center of grate 110 causes downward pressure to be concentrated on the outer edges of the pomegranate which aids in the splaying action of the pomegranate. This opening up or splaying of the pomegranate half helps to remove the seeds more quickly and efficiently. The efficiency of removing seeds can be further improved by providing circular rib 116 spaced below radial ribs 114. By spacing circular rib 116 below radial ribs 114, for example by a distance of 1 mm to 10 mm, seed removal efficiency may be further improved because the vertical space between the upper edge of circular rib 116 below radial ribs 114 prevents the pomegranate from engaging with or “catching on” circular rib 116 as the pomegranate is splayed open. Once all the seeds are thus removed from the rinds and septum of the pomegranate, the seeds can be collected beneath the housing of the seed extractor.

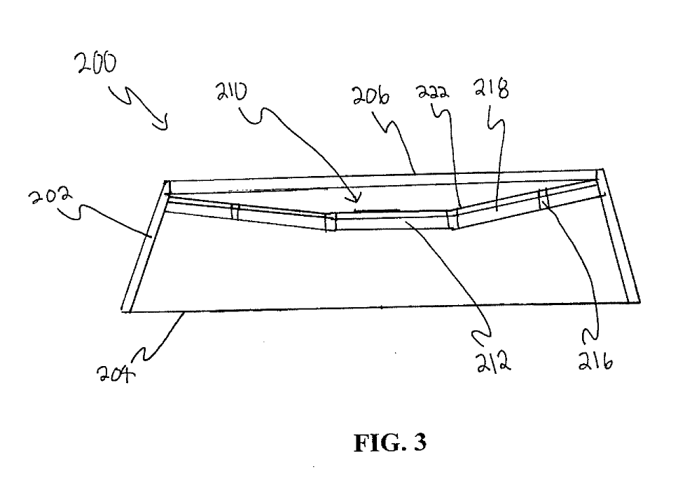

An example of another embodiment of a pomegranate seed extractor is shown in FIG. 3. Seed extractor 200 includes housing 202 with upper edge 206 and bottom edge 204. Grate 210 is mounted inside housing 202 below upper edge 206. Further, grate 210 comprises circular rib 216 which is disposed below the outer edges of grate 210 so that upper surface 222 of grate 210 is inwardly sloped. For example, the elevation difference between circular rib 216 of grate 210 and the outer edge of grate 210 may be approximately 1 mm to 10 mm, though other elevation differences are also contemplated. Grate 210 may also include a plurality of gaps 218 formed between the intersections of circular ribs 216 and radial ribs.

The embodiments disclosed above provide many advantages over traditional pomegranate fruit processing. First, using embodiments of the disclosed seed extractors allows for very rapid removal of seeds as compared with manual seed removal. Second, using the seed extractor allows seeds to be extracted without a person's hands ever coming in contact with the seeds, thereby preventing contamination. Finally, the seed extractor provides a simple and effective mechanism for quickly separating desirable parts of a pomegranate (e.g. the seeds) from the undesirable parts (e.g. the septum and rind) without wasting or destroying any of the desirable portions of the fruit.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pomegranate seed extractor, comprising:
an open-ended conical housing having a top circular edge and a bottom circular edge, each circular edge defining a circumference, wherein the circumference of the top circular edge is smaller than the circumference of the bottom circular edge; and
a grate mounted inside the housing adjacent to the top circular edge of the housing and spaced above the bottom circular edge of the housing thereby forming a seed collection chamber beneath the grate inside the housing, wherein the grate comprises at least one circular core rib and a plurality of radial ribs extending outwardly from the circular core rib;
wherein a plurality of essentially quadrilateral openings are formed between the core rib, adjacent radial ribs and the housing.

2. A method of extracting seeds from a pomegranate, comprising:
providing a pomegranate seed extractor, comprising:
an open-ended conical housing having a top circular edge and a bottom circular edge, each circular edge defining a circumference, wherein the circumference of the top circular edge is smaller than the circumference of the bottom circular edge; and
a grate mounted inside the housing adjacent to the top circular edge of the housing and spaced above the bottom circular edge of the housing thereby forming a seed collection chamber beneath the grate inside the housing, wherein the grate comprises at least one circular core rib and a plurality of radial ribs extending outwardly from the circular core rib;
wherein a plurality of essentially quadrilateral openings are formed between the core rib, adjacent radial ribs and the housing;
providing a pomegranate having a rind, septum and seeds;
slicing the pomegranate into at least two separate sliced pieces having a sliced end;
placing one sliced piece of the pomegranate on top of the grate with the sliced end facing down and contacting the grate; and
repeatedly striking the rind of the sliced piece of the pomegranate thereby causing the seeds of the pomegranate to fall through the grate into the housing while leaving the rind and septum of the pomegranate on top of the grate.

3. The method of claim 2, further comprising:
identifying parallel vertical ridges on the rind of the pomegranate;
creating a circumferential slice around the middle of the pomegranate perpendicular to the parallel vertical ridges on the rind;
scoring the parallel vertical ridges on the rind of the pomegranate;
separating the pomegranate along the circumferential slice to create the at least two separate sliced pieces of the pomegranate.

4. The method of claim 2, wherein the rind of the sliced piece of the pomegranate is repeatedly struck with a blunt instrument.
